(19) United States
(12) Patent Application Publication
(10) Pub. No.: US 2004/0123000 A1
(43) Pub. Date: Jun. 24, 2004

(54) Interface device for audiological devices and corresponding method to exchange data

(76) Inventors: Stefan Aschoff, Bubenreuth (DE); Jorg Bindner, Weisendorf (DE); Volker Riecken, Erlangen (DE); Roland Weidner, Zapfendorf (DE)

Correspondence Address: SCHIFF HARDIN, LLP, PATENT DEPARTMENT, 6600 SEARS TOWER, CHICAGO, IL, 60606-6473, US

(21) Appl. No.: 10/669,075

(22) Filed: Sep. 23, 2003

(30) Foreign Application Priority Data
Sep. 23, 2002 (DE) 102 44 136.7

(51) Int. Cl. G06F 13/12

(52) U.S. Cl. 710/65

(57) ABSTRACT

The interface between the applications of various audiological devices to various data administration systems should be improved. Therefore, a universal interface is inventively proposed that has a uniform interface for the applications and a plurality of interfaces for the various data administration systems. In addition to this, the corresponding conversion routines are provided. Moreover, a class framework can be provided in the interface, such that it achieves a consistent access to the universal interface.

### BACKGROUND OF THE INVENTION

The present invention concerns an interface device for audiological devices. Moreover, the present invention concerns a corresponding method for exchanging data for audiological devices.

For the adjustment of a hearing device by an acoustician or doctor, numerous audiological devices are normally necessary. Thus, for example, the hearing loss of a patient is measured with an audiometer, while a suitable hearing device is programmed corresponding to the audiometric data with a programming device. Furthermore, the hearing device can be checked with regard to functionality in a test box. Each of these devices has an application, and thus a proprietary format for data input and data output.

The measurement or, respectively, control data of the individual devices are administered or, respectively, filed in one or more data administration systems. An interface is necessary for the communication of an application with a data administration system. For the communication of two applications that run over a data administration system, two interfaces are thus necessary.

For integrating a plurality of applications and a plurality of data administration systems, as many interfaces are consequently necessary as there are access possibilities of applications to the data administration systems. The same data are thereby tapped or, respectively, exchanged with different applications by way of different interface technologies from different data administration systems. Currently, this has been accomplished with interface modules that were generated individually for a combination of application/interface technology/data administration system/data type. A particular disadvantage of such systems is their error susceptibility and the elaborate implementation requirements. Moreover, the different interfaces are redundantly loaded with similar routines.

### SUMMARY OF THE INVENTION

The object of the present invention is to improve the interfaces between the various applications of audiological devices and the corresponding data administration systems.

This object is inventively achieved via an interface device for audiological devices between a plurality of applications on the one hand and at least one data administration system on the other hand, with an application access device to which the plurality of applications can be connected for uniform data exchange, and a converter device that closes a connection between the application access device and the data administration system to convert respectively specific application data acquired from the application access device for the plurality of applications into a predeterminable databank format and/or to convert databank data acquired by the data administration connection device into application formats respectively specific to the plurality of applications.

Moreover, the above cited object is achieved according to the present invention by a method for exchanging data for audiological devices between a plurality of applications one the one hand and a data administration system on the other hand via a uniform data exchange of application data with a plurality of the applications via an interface device, data exchange of databank data with the at least one data administration system via the interface device, and conversion of the application data respectively specific for the plurality of application data into a predeterminable databank format for the at least one data administration system, and/or conversion of databank data into one or more application formats respectively specific to the plurality of applications.

The present invention thus advantageously enables in an advantageous manner that, with the aid of an individual interface, a data exchange between a plurality of applications and a plurality of data administration systems is possible for a plurality of different data. The error susceptibility thus drops considerably, and the implementation expenditure is greatly reduced.

An embodiment of the inventive interface device can be provided with a class library, i.e. class framework, in which each of the plurality of applications is accessible. The individual applications that have access to the class library can therewith instance objects for specific classes, such that a uniform interface can be developed for the applications.

In an advantageous manner, a state administration device may be provided in an embodiment for the plurality of applications such that the plurality of applications have mutual access to predetermined data (state sharing). Two or more applications can thus share state information and other data.

Moreover, with the state administration device, states and data of the plurality of applications can be stored in a databank forming a common access (state and data notifying). This can reduce the redundancy of the data keeping.

In an embodiment, which data administration system or systems are connected to the interface can preferably be automatically recognized with the state administration device. This further decreases the work of the applications—to determine in which data administration environment they are situated.

In an embodiment, a data keeping device, in particular a volatile storage, is preferably provided in the interface, i.e. in the interface device, to keep data for a plurality of applications. Corresponding data keeping algorithms offer the possibility to file data there, where they are next to a data administration system. The entire matching and the synchronization may ensue there externally via applications.

An interface device provided with these features offers the permits saving data in different data administration systems and exchanging data among one another with a single interface.

### DESCRIPTION OF THE DRAWINGS

The present invention is more closely explained using the attached drawings.

FIG. 1 is a block diagram of the hardware components of an audiological measurement system;

FIG. 2 is a block diagram of a data system according to the prior art;

FIG. 3 is a block diagram of an audiological data system according to and embodiment of the present invention; and

FIG. 4 is a block diagram illustrating the components of the inventive interface.

### DETAILED DESCRIPTION OF THE PREFERRED EMBODIMENTS

The subsequent exemplary embodiments are preferred embodiments of the present invention.

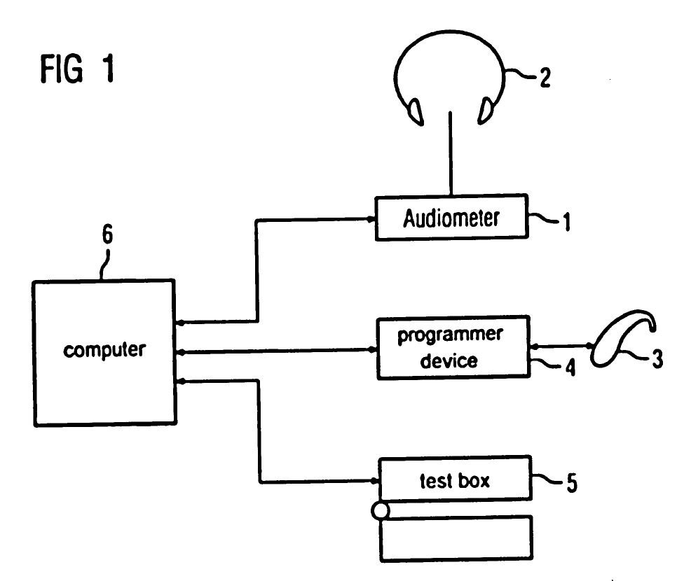

A block diagram of a typical hardware assembly of the instruments of an acoustician is shown in FIG. 1. The hearing of a patient is measured with an audiometer 1 to which headphones 2 are connected. A hearing device 3 is programmed by a programmer device. After programming, the hearing device 3 is checked in a test box for functionality. Each of the devices 1, 4, and 5 has a software application to control the device 3 and to exchange data. The devices are connected with a computer 6 that supplies the inventively uniform interface (not shown) and corresponding data administration systems (likewise not shown).

The individual devices can communicate among one another or even with one or more data administration systems via the common interface. The data administration systems (that, as a rule, comprise databanks) can be integrated in the computer 6 or even made available over corresponding data networks.

A block diagram of a data system according to the prior art is illustrated in FIG. 2. Corresponding to the example from FIG. 1, for quality assurance, an audiometry application 11 is provided for the audiometer 1, a fitting application 14 is provided for the programmer device 4, and a test box measurement application 15 is provided for the test box 5. In a computer 6 according to the prior art, a plurality of interfaces 61 through 66 is available for the communication with a data administration system. Typically, in such a configuration three data administration systems 71, 72, and 73 are used.

No direct connection exists between the individual applications 11, 14, and 15. For the access of the audiometry application 11 to a Noah data administration system 71, a Noah interface is available for audiometry 61. An ASCII interface for audiometry 62 serves as access of the audiometry application 11 to an ASCII data administration system 73. In a similar manner, the adjustment or fitting application 14 has access to the Noah data administration system 71 via a Noah interface for the adjustment 63. A connection exists from the fitting application 14 to an IDAPI data administration system 72 via an IDAPI interface for the adjustment 64. Moreover, an IDAPI interface connects the test box measurement application 15 with the image acquisition system 72 for the test box 65, Finally, an ASCII interface connects the test box measurement application 15 with the ASCII data administration system 73 for the test box 66. These interface connections merely present a selection, and can be supplemented as necessary. For example, an IDAPI interface can also be provided for the audiometry application 11.

To exchange data, for example between the audiometry application 11 and the fitting application 14, two interfaces are necessary that produce a connection to a common data administration system. In the present case, according to FIG. 2, these are the two Noah interfaces 61 and 63. The test box measurement application 15 communicates with the audiometry application 11, for example via the two ASCII interfaces 62 and 66 and the mutual ASCII data administration system 73.

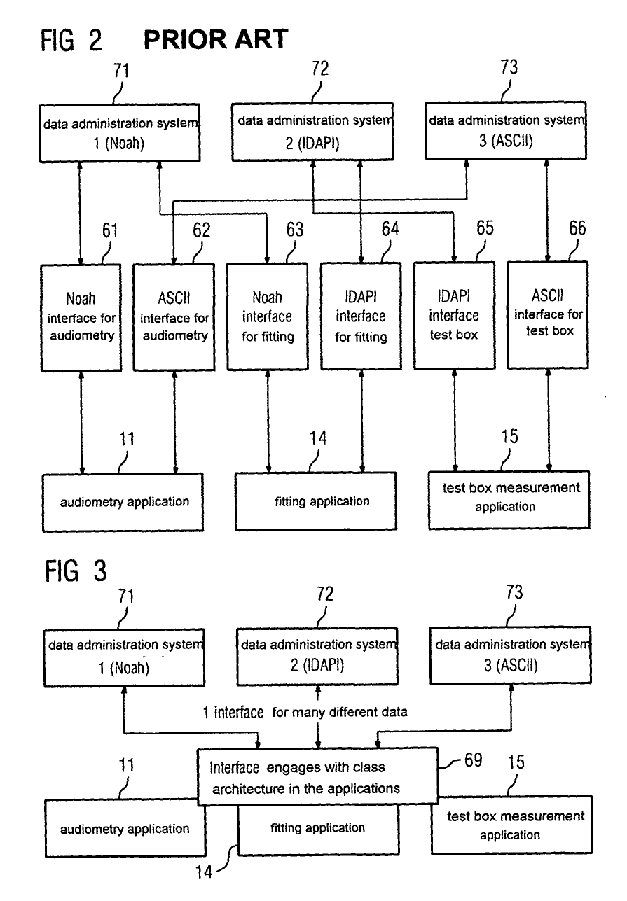

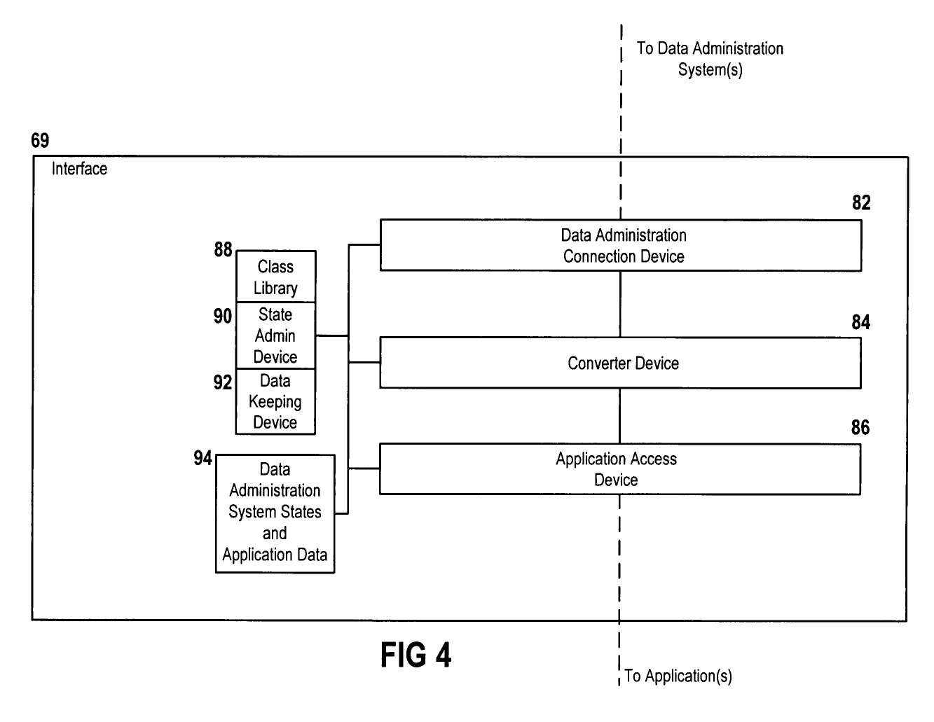

The plurality of interfaces 61 through 66 is inventively replaced by a single interface 69, as indicated in FIGS. 3 and 4. This interface 69 comprises the following components or, respectively, features:

A class framework that represents a class library 88. With this framework, it is possible that the interface 69 engages with the class architecture in the applications 11, 14 and 15.

Conversion routines that may be located in a converter device 84 that effect the corresponding data conversions, since, for example, the audiometry data may exhibit a different structure in each databank.

A uniform interface for applications that may be located in an application access device 86 that enables a consistent connection of the interface 69 to the various applications 11, 14 and 15.

A quantity of interfaces for various data administration systems that may be located in a data administration connection device 82. These are necessary in order to give the respectively specific connection for the individual data administration systems 71 through 73.

“State sharing” and “state and data notifying” externally via applications. This ensures that two applications share a state, i.e. data, and (as the case may be) may store this state in a databank 94.

Data keeping algorithms. These offer the possibility to file data where it is next to the data administration system. The data may be buffered in a volatile storage, for example, for a rapid access.

The cited components and featured offer the universal interface 69 the possibility to store data in different data administration systems with a single interface, and to exchange data among one another. Each application can use the class library 88 and thereby obtains consistent access to the mutual interface 69. Consequently, each application can deliver and receive data in standardized form. The framework 69 comprises, among other things, objects that enable the data administration to the user.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

Reference List

1 audiometer

2 headphones

3 hearing device

4 programmer device

5 test box

6 computer

11 audiometry application

14 fitting application

15 test box application

61 interface

62 interface

63 interface

64 interface

65 interface

66 interface

69 interface

71 data administration system

72 data administration system

73 data administration system

82 data administration connection device

84 converter device

86 application access device

88 class library

90 state administration device

92 data keeping device

94 data administration system states and application data (databank)

What is claimed is:

1. An interface device for audiological devices between a plurality of applications and at least one data administration system, comprising:
an application access device to which the plurality of applications can be connected for uniform data exchange,
a data administration connection device to which at least one data administration system can be connected, and
a converter device, that closes a connection between the application access device and the data administration connection device, the converter device being configured to perform at least one of: a) converting respectively specific application data acquired by the application access device in a predeterminable databank format for the plurality of applications, and b) converting databank data acquired from the data administration connection device into one or more respectively specific application formats for the plurality of applications.

2. The device according to claim 1, further comprising a class library that is accessible with each of the plurality of applications.

3. The device according to claim 1, further comprising a state administration device for the plurality of applications, such that the plurality of applications have common access to predeterminable data.

4. The device according to claim 3, further comprising a databank in which states and data of the plurality of applications can be stored for common access via the state administration device.

5. The device according to claim 3, wherein the state administration device is configured to automatically recognize which data administration system or systems are connected to the device.

6. The device according to claim 1, further comprising a data keeping device to keep data for a plurality of the applications.

7. The device according to claim 6, wherein the data keeping device comprises a volatile storage.

8. A method for data exchange for audiological devices between a plurality of applications and at least one data administration system, comprising:
uniformly exchanging data comprising application data with the plurality of applications via an interface device;
exchanging data stored in a databank with at least one data administration system via the interface device; and
at least one of:
a) converting application data respectively specific to the plurality of applications into a predeterminable databank format for the at least one data administration system; and
b) converting databank data acquired into one or more application formats respectively specific to the plurality of applications.

9. The method according to claim 8, further comprising enabling the uniform data exchange by a class library to which each of the plurality of applications is accessed.

10. The method according to claim 8, further comprising providing the plurality of applications with mutual access to the predeterminable data.

11. The method according to claim 10, further comprising storing states and data of the plurality of applications in a databank for common access.

12. The method according to claim 8, further comprising automatically recognizing which of the data administration system or systems is connected.

13. The method according to claim 8, further comprising holding data internal to the interface device for the plurality of the applications.

14. The method according to claim 13, wherein the holding of the data is done in a volatile memory.
